(19) United States
(12) Patent Application Publication
(10) Pub. No.: US 2011/0240540 A1
(43) Pub. Date: Oct. 6, 2011

(54) AQUEOUS IRON REMOVAL PROCESS AND APPARATUS

(76) Inventor: James Jeffrey HARRIS, Cameron Park, CA (US)

(21) Appl. No.: 13/075,974

(22) Filed: Mar. 30, 2011

Related U.S. Application Data
(60) Provisional application No. 61/319,000, filed on Mar. 30, 2010.
(60) Provisional application No. 61/328,892, filed on Apr. 28, 2010.

(51) Int. Cl. B01D 15/00

(52) U.S. Cl. 210/198.1

(57) ABSTRACT

A process and associated apparatus to reduce both ferrous (Fe⁺⁺) iron and ferric (Fe⁺⁺⁺) iron from an aqueous solution. A pH swing process is described in which a phosphoric acid solution is first added and then a base chemical is added. The combination results in generation and precipitation of iron phosphate. The method and apparatus affords flocculent enhanced settling and removal of the iron precipitates and process suitable buffering of the resulting reduced iron aqueous solution.

### CROSS-REFERENCE TO RELATED APPLICATIONS

This application for patent claims priority to U.S. Provisional Patent Application Ser. No. 61/319,000, filed Mar. 30, 2010 and entitled “Aqueous Iron Removal Process and Device” and U.S. Provisional Application Ser. No. 61/328,892, filed Apr. 28, 2010 entitled “Aqueous Iron Removal Process and Apparatus” which are both incorporated by reference herein to the extent permitted by law.

### BACKGROUND OF THE INVENTION

This invention relates to a chemical based process for the removal of both Ferric (FE⁺⁺⁺) and especially Ferrous (FE⁺⁺⁺) iron from aqueous, solutions.

Iron contamination of water is a prevalent industrial problem. Two types of aqueous iron are possible; Fe⁺⁺⁺ (ferric) and Fe⁺⁺ (ferrous). Ferric iron is insoluble in most aqueous solutions; precipitating as a solid residue and engendering aqueous discoloration. Prior to process use of a ferric entrained aqueous solution, ferric iron can be settled, chemically coagulated and/or filtered eliminating problems associated with solids deposition and or solution discoloration. In contrast, ferrous iron purveys a dissolved, passive state in aqueous solution. Unfortunately, soluble ferrous iron oxidizes readily into insoluble ferric iron subsequent to contact with oxygen (air). Accordingly, problems associated ferric iron precipitation and discoloration can occur even though an anoxic aqueous solution had been previously treated to remove ferric iron precipitates and discoloration. This problem is especially burdensome with anoxic waters such as water and brine sourced from deep aquifers, oil and gas production operations, mine drainage and similar scenarios. In such oxygen deprived waters the ferrous form of dissolved iron is often present. Eventual contact with oxygen (air) oxidizes the soluble ferrous iron transforming it into the insoluble ferric form with consequential discoloration of the aqueous solution and precipitation of the ferric solid; resulting in detrimental fouling and plugging of pipes, valves, pumps and other process equipment.

The focus of the invention is to remove both the ferrous and the ferric iron from anoxic brines associated oil and gas production. Plugging of wells, pipelines, tanks, heat exchangers and other process equipment is a prevalent and serious problem associated with iron precipitation and deposition.

There are numerous filtration appliances, ion exchange media and oxidation processes available in the prior art to remove the offending irons but these methods are hindered by troublesome fouling and plugging with ferric iron and poor removal efficiency of the ferrous iron. The prior art is additionally burdened by solid media expense, consumption and disposal with a corresponding environmental liability. Further, the efficacy of the prior art is hindered by the by the characteristic presence of oils and light hydrocarbons in oil and gas production brines. These materials seriously contaminate, foul and blind the appliances, media and processes of the prior art. Reference the following US patents provide examples of the prior art: U.S. Pat. Nos. 7,481,929 (Wilkins et al.), 7,399,416 (Moller et al.), 6,555,151 (Hu et al.), 6,521,810 (Shapiro et al.), 6,440,300 (Randall et al.), 6,177,015 (Blakey et al.), 6,113,779 (Snee), 5,948,264 (Dreisinger et al.), 5,919,373 (Naaktgeboren) and 5,910,253 (Fuerstenau et al.).

### BRIEF SUMMARY OF THE INVENTION

The foregoing discussion focuses on efforts of the prior-art to provide effective means to eliminate ferrous and ferric iron from aqueous solutions, wherein of particular interest, said aqueous solutions are the brines associated with oil and gas production. The prior art fails to address the elimination of these iron materials in an efficient manner. The prior art further demonstrates many other disadvantages due to unreliability, expense and environmental liability associated with spent material disposal concerns.

The reader who is knowledgeable in the art will clearly recognize the substantial benefits as well as the unique and distinctively superior capabilities afforded by the invention; presenting a cost effective, practical, reliable and environmentally friendly means for removing both ferric and ferrous iron from aqueous solutions.

The invention described herein provides a simple chemical and pH controlled means to precipitate both ferric and ferrous iron from aqueous solutions; facilitating minimal residual iron content. In summary, a process is provided wherein a ferric and/or ferrous entrained aqueous solution is elevated in pH with a base chemical such as sodium or calcium hydroxide to a pH level rendering precipitation of the ferric iron. In the preferred embodiment a coagulant such as an anionic polymer may be added to the elevated pH mixture to accelerate ferric precipitation. Ferric entrained solids are then separated from the elevated pH solution.

The elevated pH solution is then buffered with phosphoric acid to facilitate precipitation of the residual ferrous iron. In the preferred embodiment a coagulant such as an anionic polymer may be added to the buffered mixture to accelerate residual iron precipitation. Iron entrained solids are then separated from the elevated pH solution. The buffered, essentially iron free aqueous solution is then conveyed for process use.

The foregoing has outlined rather broadly the features and technical advantages of the present invention in order that the detailed description of the invention which follows may be better understood. Additional features and advantages of the invention will be described hereinafter, which form the subject of the claims of the invention. It should be appreciated by those skilled in the art that the concepts and specific embodiments disclosed herein may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### OBJECTS AND ADVANTAGES

The invention purveys a chemically staged pH swing process for simple, efficient and cost effective removal of ferric and ferrous iron from an iron entrained aqueous solution. The invention employs addition of base chemical, such as sodium hydroxide, to elevate the pH of an iron bearing solution, followed by pH buffering with phosphoric acid to a lowered or neutral state pH, the effect affording extraction and precipitation of both ferric and ferrous iron as insoluble solids, separable from the solution. The invention provides multiple objects and advantages over the prior art. Some of which are as follows.

The removal of iron is unimpeded by the presence of oils or hydrocarbons, conveying a distinct advantage over the prior art; auspiciously pertaining to iron removal from oil and gas production brines. In this application the invention proffers elimination of expensive and troublesome equipment required for removal of oils and hydrocarbons prior to the iron extraction practices of the prior art.

The invention employs a strictly chemical based process eliminating specific appliance or hardware limitations. Since a primary focus of the invention is treatment of very corrosive oil and gas production brines, the expense and impracticality associated with exotic, corrosion resistant materials of construction necessary for appliance of the prior art are not required.

The invention employs simple and inexpensive chemicals rather than one or more of the ion exchange medias common to the prior art. Such medias are burdened by sensitivity to blinding, fouling and/or poisoning by extraneous salts, metals and other common contaminants entrained in the iron bearing solutions. This is particularly problematic with oil and gas production brines; the focus of the invention. Media life is exceptionally short when treating these brines. Accordingly, the invention purveys a substantially more reliable, longer life, more efficient course for removal of entrained iron than the media based technologies of the prior art. Further, the invention does not beget the disposal expense and associated environmental liabilities burdensome to the media based technologies of the prior art.

The invention does not require additional chemicals to refurbish media as is a common practice of the prior art. Accordingly the invention eliminates the expense, storage and handling associated with the washing and regeneration chemicals employed by the prior art. Further, since the invention does not require such additional chemicals, the expense and environmental liabilities associated with disposal of spent volumes of these chemicals is eliminated.

Variations in water constituents can dramatically and negatively affect the performance of many examples of the prior. Such changes are especially common with oil and gas production brines. In contrast to the sensitivity that the prior art often demonstrates to such changes, the invention is robust in accommodating varying constituents.

### BRIEF DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a process diagram of an embodiment of the invention employing direct addition of base chemical and phosphoric acid into a receiving vessel;

FIG. 2 is a process diagram of an embodiment of the invention employing two containment vessels with chemical addition into the confines of the vessels;

FIG. 3 is a process diagram of an embodiment of the invention employing two vessels with piping conveyance incorporating base chemical and phosphoric acid addition;

FIG. 4 is a process diagram of an embodiment of the invention employing two vessels with piping conveyance incorporating base chemical and phosphoric acid addition as well as providing pipeline conveyed mixing;

FIG. 5 is a process diagram of an embodiment of the invention employing two containment vessels with chemical addition, inclusive of agglomeration chemicals into the confines of the vessels;

FIG. 6 is a process diagram of an embodiment of the invention employing two vessels with piping conveyance incorporating base chemical, phosphoric acid and agglomerating chemicals;

FIG. 7 is a process diagram of the preferred embodiment of the invention employment two vessels with piping conveyance incorporated base chemical, phosphoric acid and agglomerating chemicals as well as providing pipeline conveyed mixing; and

FIG. 8 is a process diagram of an embodiment of the invention employing two containment vessels with chemical addition, inclusive of agglomeration chemicals into the confines of the vessels wherein mixing appliances are provided.

### REFERENCE NUMERALS IN THE DRAWING

1 Containment vessel
5 Iron imbued solids
10 Iron entrained aqueous solution (brine) feed
20 First containment vessel base reaction vessel
25 First containment vessel mixing appliance
30 Base chemical addition
35 Base chemical mixer
40 First agglomerating chemical
45 First agglomerating chemical mixer
50 Ferric fostered solid precipitates
60 First containment vessel effluent
70 Second containment vessel buffering reaction vessel
75 Second containment vessel mixer
80 Phosphoric acid entrainment
85 Phosphoric acid mixer
90 Second agglomerating chemical
95 Second agglomerating chemical mixer
100 Ferrous fostered solid precipitates
110 Low iron content water (brine)

### DETAILED DESCRIPTION OF THE INVENTION

The making and using of the embodiments illustrated herein are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. The present invention will be described with respect to the subject embodiments in a specific context, namely as a device and process for reduction of iron in aqueous or brine based solutions. The invention may also be applied, however, to other situations wherein similar iron reduction effects are desired.

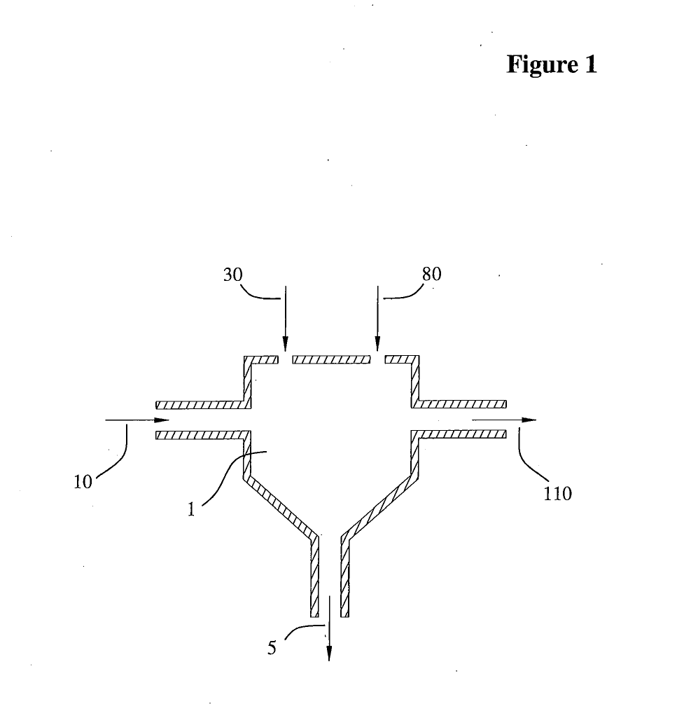

Description—FIG. 1—Direct to obtaining the effect of the invention a typical embodiment is illustrated on FIG. 1 and is described as follows. Iron entrained aqueous solution (brine) 10 is conveyed into a containment vessel 1 wherein a pH raising base chemical 30, such as sodium hydroxide, is added. Ferric iron fostered precipitates separate from solution as an iron bearing insoluble solids discharge 5. PH buffering phosphoric acid 80 is added into the containment vessel 1. Ferrous iron fostered precipitates separate from solution as iron bearing insoluble solids discharge 5. A minimal iron imbued supernatant 110 is conveyed from the containment vessel 1 for process use.

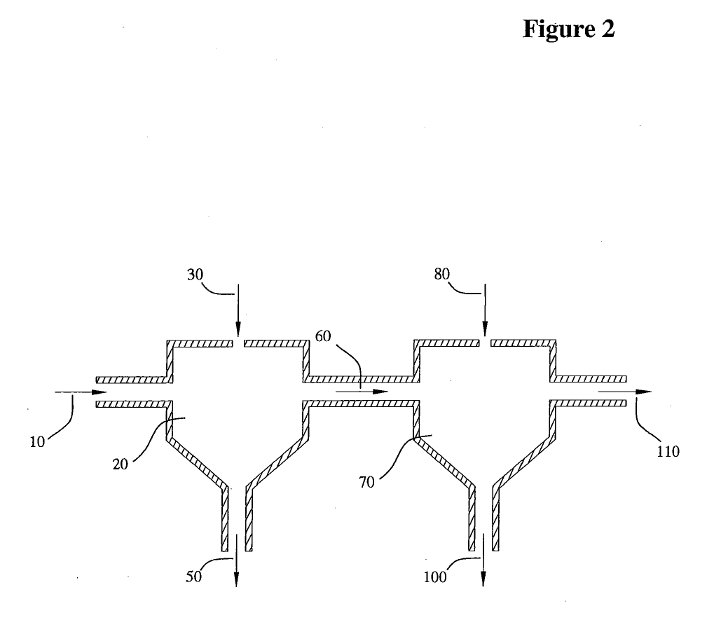

Description—FIG. 2—Direct to obtaining the effect of the invention a typical embodiment is illustrated on FIG. 2 and is described as follows. Iron entrained aqueous solution (brine) 10 is conveyed into a first containment base reaction vessel 20 wherein a pH raising base chemical 30, such a sodium hydroxide, is added. Ferric iron fostered precipitates separate from solution as iron bearing insoluble solids 50. A reduced iron effluent 60 egresses the base reaction vessel 20 and having pH buffering phosphoric acid added 80, mixed 85, and entrained therein, is conveyed into a second containment buffering reaction vessel 70. Ferrous iron fostered precipitates separate from solution as iron bearing insoluble solids 100. A minimal iron imbued supernatant 110 is conveyed from vessel 70 for process use.

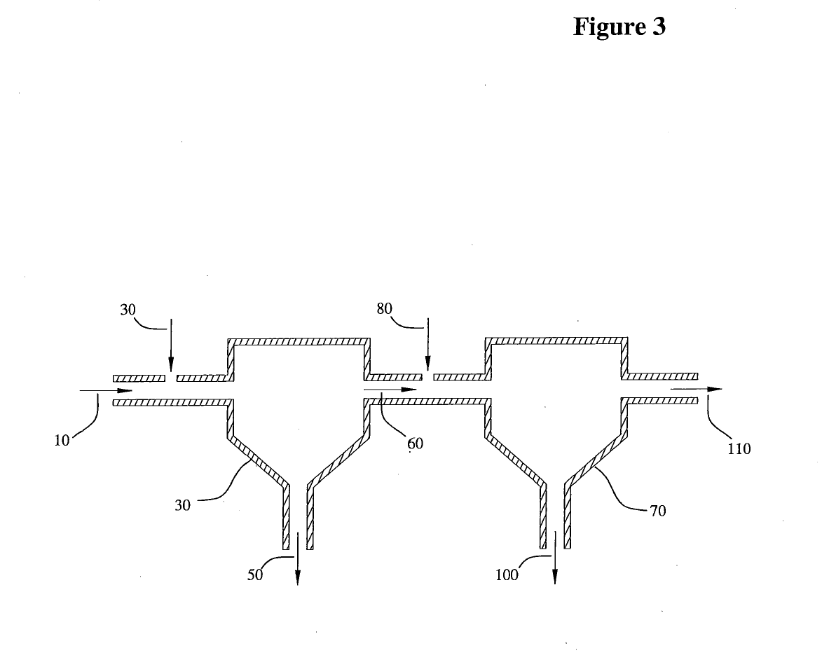

Description—FIG. 3—Direct to obtaining the effect of the invention another typical embodiment is illustrated on FIG. 3 and is described as follows. Iron entrained aqueous solution (brine) 10, having a pH raising base chemical 30, such as sodium hydroxide, added and entrained therein, is conveyed into a first containment; base reaction vessel 20. Ferric iron fostered precipitates separate from solution as iron bearing insoluble solids 50. A reduced iron effluent 60 egresses the base reaction vessel 20 and having pH buffering phosphoric acid added 80, mixed 85, and entrained therein, is conveyed into a second containment buffering reaction vessel 70. Ferrous iron fostered precipitates separate from solution as iron bearing insoluble solids 100. A minimal iron imbued supernatant 110 is conveyed from vessel 70 for process use.

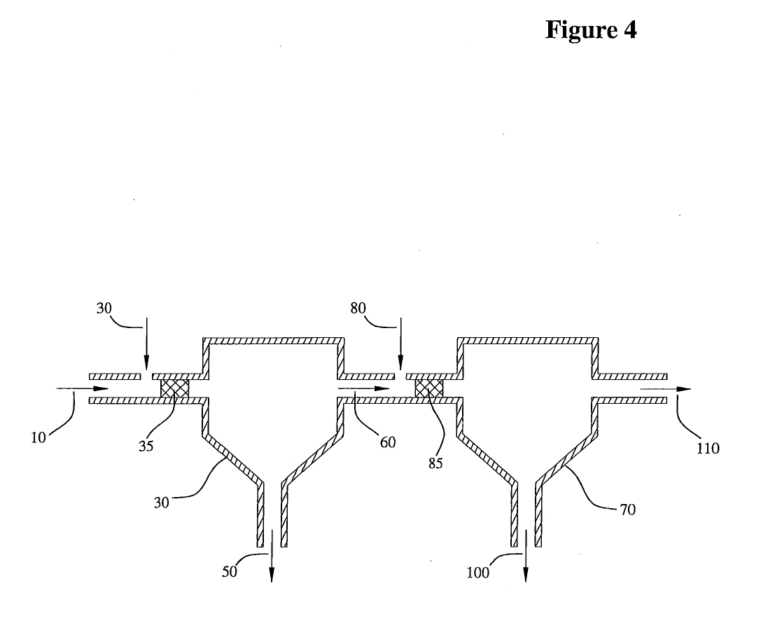

Description—FIG. 4—Direct to obtaining the effect of the invention another typical embodiment is illustrated on FIG. 4 and is described in the following discussion. Iron entrained aqueous solution (brine) 10 having a pH raising base chemical 30 added, mixed 35, and entrained therein, is conveyed into a first containment base reaction vessel 20. Ferric iron fostered precipitates separate from solution as iron bearing insoluble solids 50. The reduced iron effluent 60 egresses the base reaction vessel 20 and having phosphoric acid added 80, mixed 85, and entrained therein, is conveyed at a lowered pH into a second containment buffering reaction vessel 70. Ferrous iron fostered precipitates separate from solution as iron bearing insoluble solids 100. A minimal iron imbued supernatant 110 is conveyed from vessel 70 for process use.

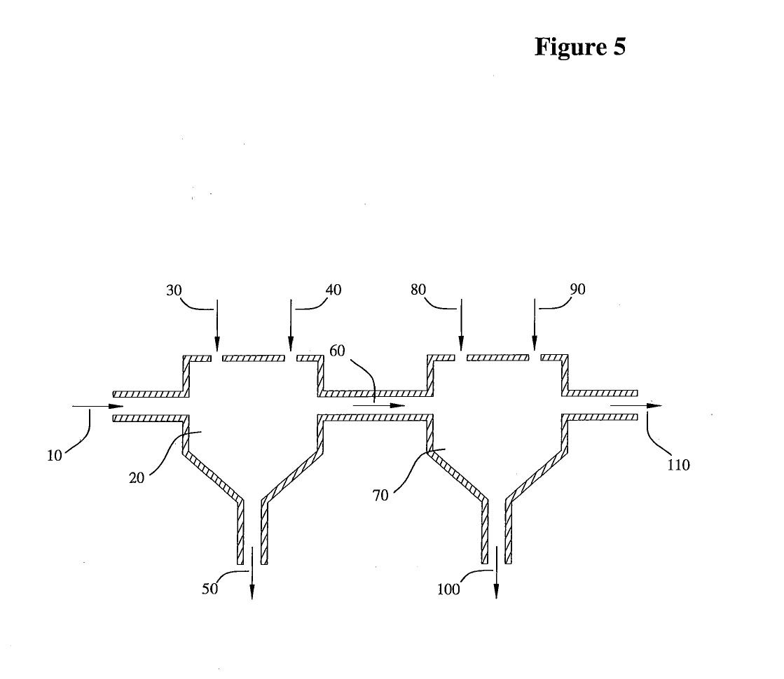

Description—FIG. 5—Direct to obtaining the effect of the invention another typical embodiment is illustrated on FIG. 5 and is described in the following discussion. Iron entrained aqueous solution (brine) 10 is conveyed into a first containment base reaction vessel 20 wherein a base chemical 30 is added to increase pH and an agglomerating chemical 40 is added to augment solids precipitation. Ferric iron fostered precipitates separate from solution as iron bearing insoluble solids 50. The reduced iron effluent 60 egresses the reaction vessel 20 and is conveyed into a second containment pH buffering reaction vessel 70. PH buffering phosphoric acid 80 and a second agglomeration chemical 90 are added into the buffering reaction vessel 70. Ferrous iron fostered precipitates separate from solution as iron bearing insoluble solids 100. A minimal iron imbued supernatant 110 is conveyed from vessel 70 for process use.

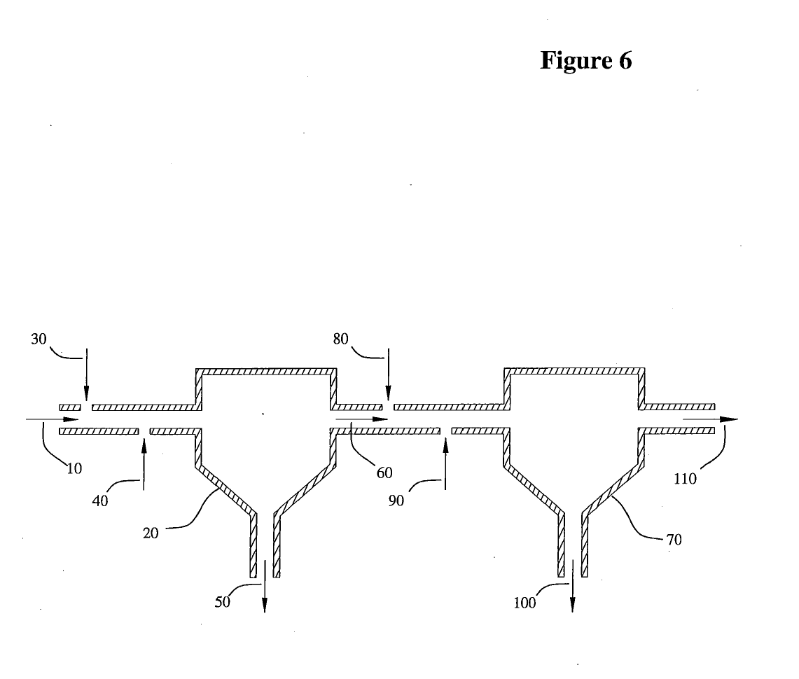

Description—FIG. 6—Direct to obtaining the effect of the invention another typical embodiment is illustrated on FIG. 6 and is described as follows. Iron entrained aqueous solution (brine) 10, having a pH raising base chemical 30, such as sodium hydroxide, and an agglomeration chemical 40, such as a metal salt or polymer, added and entrained therein, is conveyed into a first containment base reaction vessel 20. Ferric iron fostered precipitates separate from solution as iron bearing insoluble solids 50. A reduced iron effluent 60 egresses the base reaction vessel 20 and after having pH buffering phosphoric acid 80 and a second agglomeration chemical 90, such as a metal salt or polymer, added and entrained therein, is conveyed into a second containment buffering reaction vessel 70. Ferrous iron fostered precipitates separate from solution as iron bearing insoluble solids 100. A minimal iron imbued supernatant 110 is conveyed from vessel 70 for process use.

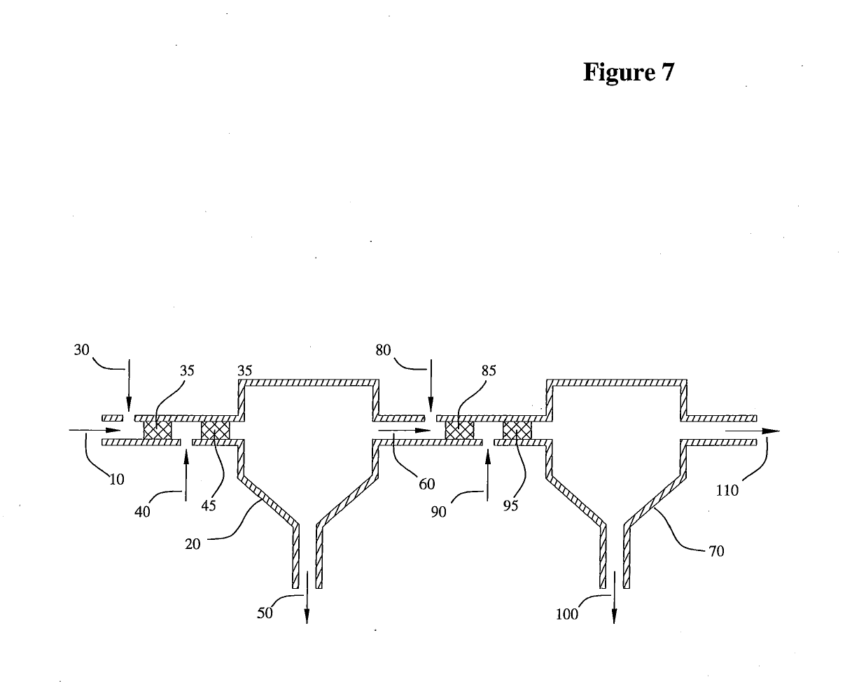

Description—FIG. 7—Direct to obtaining the effect of the invention a preferred embodiment is illustrated on FIG. 7 and is described as follows. Iron entrained aqueous solution (brine) 10, having a pH raising base chemical 30, such as sodium hydroxide, added and mixed 35 and an agglomeration chemical 40, such as a metal salt or polymer, added and mixed 45, is conveyed into a first containment base reaction vessel 20. Ferric iron fostered precipitates separate from solution as iron bearing insoluble solids 50. A reduced iron effluent 60 egresses the base reaction vessel 20 and after having pH buffering phosphoric acid 80 added and mixed 85 and a second agglomeration chemical 90, such as a metal salt or polymer, added and mixed 95, is conveyed into a second containment buffering reaction vessel 70. Ferrous iron fostered precipitates separate from solution as iron bearing soluble solids 100. A minimal iron imbued supernatant 110 is conveyed from vessel 70 for process use.

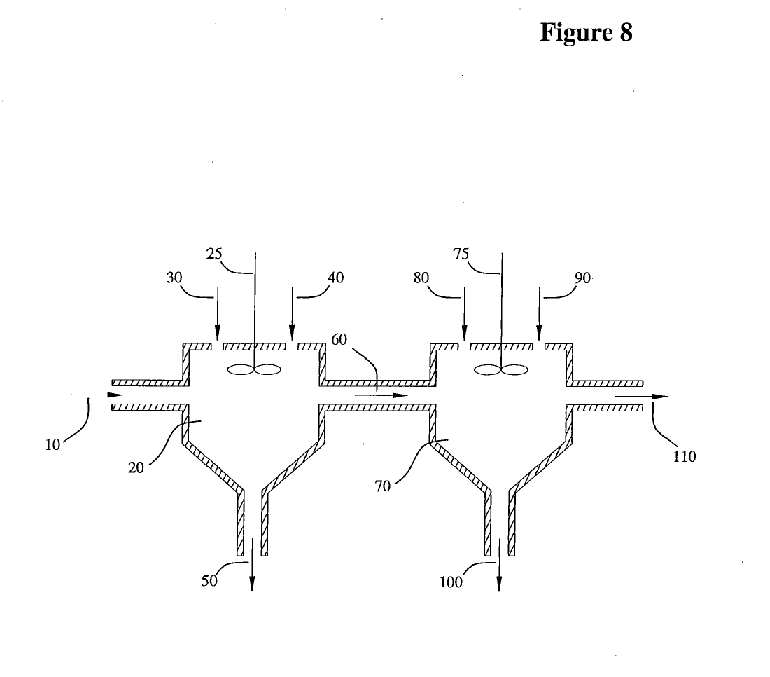

Description—FIG. 8—Direct to obtaining the effect of the invention another typical embodiment is illustrated on FIG. 8 and is described in the following discussion. Iron entrained aqueous solution (brine) 10 is conveyed into a first containment base reaction vessel 20 having a first containment vessel mixing appliance 25 wherein a base chemical 30 is added to increase pH and an agglomerating chemical 40 is added to augment solids precipitation. Vessel mixing appliance 25 may be continuously stirring solution 10 and chemicals 30, 40 or may be activated when needed. Ferric iron fostered precipitates separate from solution as iron bearing insoluble solids 50. The reduced iron effluent 60 egresses the reaction vessel 20 and is conveyed into a second containment pH buffering reaction vessel 70 having a second containment vessel mixer 75. PH buffering phosphoric acid 80 and a second agglomeration chemical 90 are added into the buffering vessel 70. Vessel mixer 75 may be continuously stirring effluent 60, phosphoric acid 80 and chemical 90 or may be activated when needed. Ferrous iron fostered precipitates separate from solution as iron bearing insoluble solids 100. A minimal iron imbued supernatant 110 is conveyed from vessel 70 for process use.

In certain embodiments, the invention does not require additional chemicals to refurbish media as is a common practice of the prior art. Accordingly, certain embodiments of the invention eliminate the expense, storage and handling associated with said washing and regeneration chemicals. Further, additional chemicals are not required, the expense and environmental liabilities associated with disposal of spent volumes of these chemicals is eliminated.

Variations in water constituents can dramatically and negatively affect the performance of many examples of the prior art. Such changes are especially common with oil and gas production brines. In contrast to the sensitivity that the prior art often demonstrates with such changes, the invention is robust in accommodating these changes.

The making and using of the embodiments illustrated herein are discussed in detail below. It should be appreciated, however, that the present invention provides many applicable inventive concepts that can be embodied in a wide variety of specific contexts. The specific embodiments discussed herein are merely illustrative of specific ways to make and use the invention, and do not limit the scope of the invention. The present invention will be described with respect to the subject embodiments in a specific context, namely as a device and process for reduction iron in aqueous or brine based solutions. The invention may also be applied, however, to other situations wherein similar iron reduction effects are desirable.

Description—FIG. 1—One embodiment of the present invention is illustrated in FIG. 1, wherein iron entrained aqueous solution (brine) 10 is conveyed into an acidic reaction vessel 20 wherein a phosphoric acid solution 30 is added to reduce the pH of the brine. The low pH brine conveys from the acidic reaction vessel 20 into the base reaction vessel 40 wherein a base chemical 50 is added to elevate the pH. Iron phosphate 80 precipitates from the solution in reaction vessel 40 and exits the reaction vessel 40. The reduced iron supernatant 70 separates from the precipitate and exits the reaction vessel 40 in conveyance to the buffering vessel 90. Acidic chemical 100 is added in the buffering reaction vessel 90 to lower the pH to a suitable level and the reduced iron precipitant 130 is conveyed to process.

Description—FIG. 2—Another embodiment of the present invention is illustrated in FIG. 2, wherein iron entrained aqueous solution (brine) 10 is conveyed into a pipeline 25 wherein, while in transit, a phosphoric acid solution 30 is added to reduce the pH of the brine. Further in transit a base chemical 50 is added to elevate the pH. The elevated pH brine then enters a base reaction vessel 40 providing quiescence necessary for settling of precipitating iron phosphate. The reduced iron supernatant 70 separates from the precipitate and exits the base reaction vessel 40. Iron phosphate 80 separates from the elevated pH brine and exits from the reaction vessel 40. Reduced iron supernatant 70 conveys via pipeline 95 from the reaction vessel 40. Acidic chemical 100 is added into the pipeline 95 to lower the pH of the reduced iron brine to create a reduced iron precipitate 130 suitable with suitable pH for conveyance to process.

Description—FIG. 3—Another embodiment of the present invention is illustrated in FIG. 3, wherein iron entrained aqueous solution (brine) 10 is conveyed into a reaction vessel 20 wherein a phosphoric acid solution 30 is added to reduce the pH of the brine. The lowered pH brine is then conveyed into a second reaction vessel 40 wherein a base chemical 50 is added to raise the pH to afford precipitation of iron phosphate from the brine solution. An additional flocculating chemical 60 is added into the precipitating brine solution in reaction vessel 40 to accelerate and enhance the precipitate settling and separation effects. The settled iron phosphate 80 exits the reaction vessel 40. The reduced iron supernatant 70 separates from the precipitate and exits the reaction vessel 40 and conveys into buffering vessel 90 wherein an acidic chemical 100 is added to lower the pH of the reduced iron brine to a suitable pH for process use. As a consequence of the reduction of the pH, additional precipitate may form for which the buffering vessel 90 provides quiescence for settling and separation. An additional flocculating chemical 110 is added into buffering vessel 90 to accelerate and enhance the precipitate settling and separation effects. The settled precipitate 120 exits the reaction vessel 90. The reduced iron precipitate 130 exits the reaction vessel 90 to process.

Description—FIG. 4—Another embodiment of the present invention is illustrated in FIG. 4, wherein iron entrained aqueous solution (brine) 10 is conveyed into a pipeline 25 wherein, while in transit, a phosphoric acid solution 30 is added to reduce the pH of the brine. A mixing appliance 35, such as a static pipeline mixer, is provided downstream of the addition of the phosphoric acid solution 30 to enhance mixing of the phosphoric acid into the brine solution. Further in transit down the pipeline 25, a base chemical 50 is added to the flowing brine to elevate the pH. A mixing appliance 35, such as a static pipeline mixer, is provided downstream of the addition of the base chemical 50 to enhance mixing and elevation of the flowing brine pH in the pipeline 25. As a consequence of the elevated pH, iron phosphate precipitate forms in the flowing brine. Further in transit down the pipeline 25 a flocculating chemical 60, is added to the flowing brine to enhance the precipitation of iron phosphate. A mixing appliance 35, such as a static pipeline mixer, is provided downstream of the addition of the flocculating chemical 60 to enhance mixing and contacting between precipitates and the flocculating chemical 60. The elevated pH brine with entrained flocculating precipitates enters a reaction vessel 40 providing quiescence necessary for settling of precipitating iron phosphate. The reduced iron supernatant 70 separates from the precipitate and exits the reaction vessel 40. Iron phosphate 80 precipitate from the elevated pH brine and exits from the reaction vessel 40. Reduced iron supernatant 70 with high pH conveys via pipeline 95 from the reaction vessel 40. Acidic chemical 100 is added into the pipeline 95 to lower the pH of the reduced iron brine to a suitable pH for eventual process use. A mixing appliance 35, such as a static pipeline mixer, is provided downstream of the addition of the acidic chemical 100 to enhance homogeneous pH reduction. As a consequence of the lowered pH, various precipitates can form in the flowing brine. Further in transit down the pipeline 95, an additional flocculating chemical 110 is added to the flowing brine to enhance the aggregation of precipitates. A mixing appliance 35, such as a static pipeline mixer, is provided downstream of the addition of the additional flocculating chemical 110 to enhance mixing and contacting between precipitates and the flocculating chemical. The buffered pH brine with entrained flocculating precipitates enters a buffering vessel 90 providing quiescence necessary for settling of precipitates. The buffered, reduced iron supernatant 130 separates from the precipitate and exits from the buffering vessel 90. Settled precipitates 120 separate from the buffered pH brine and exit from the buffering vessel 90. The reduced iron precipitate 130 exits the reaction vessel 90 to process.

Those skilled in the art recognize that the invention provides a means to efficiently and robustly remove both ferrous (Fe⁺⁺) iron and ferric (Fe⁺⁺⁺) iron from an aqueous solution (brine). The advantages over the prior art are substantial and include, among many others:

Oils and entrained hydrocarbons or grease do not hinder the process; thereby eliminating pretreatment requirements and associated capital, operating and labor expenses.

Certain embodiments of the invention employ chemicals which minimize the requirement for hardware, appliances and other components prone to damage from the corrosive effects of oil and gas production brines.

Certain embodiments of the invention employ fluid based chemical reactions; not requiring ion exchange or other type of contacting media. Without the employ of such media the blinding, poisoning and fouling problems associated with the media techniques of the prior art are eliminated.

Certain embodiments of the invention eliminate the use of the media common to the prior art, thereby eliminating the environmental expense and liabilities associated with disposal of spent media.

Certain embodiments of the invention do not employ media requiring chemical regeneration.

Certain embodiments of the invention employ chemicals wherein the dosage is controlled by pH. Such control affords the flexibility of successful iron removal regardless of the customary variations of brine constituents which afflicts oil and gas production brines.

While the foregoing discussions specify the many advantages inherent to the invention these do not constitute the full scope of the inventions advantages. There are many advantages beyond those defined herein. In a similar manner, the embodiments described in the foregoing are not the only embodiments possible. Other embodiments are possible.

Embodiments wherein various combinations of sections of the foregoing embodiments are certainly conceivable. Also, in certain embodiments beneficial appliances may be employed. Example of such would be the employ of centrifugal separation devices such as centrifuges or hydrocyclones to accelerate precipitate removal. Filtration devices could also be so used.

In certain embodiments thermal processes could be also employed. An example would be heating of reaction vessels to expedite pH and mixing reactions. Another possibility would be heating or cooling to expedite the precipitate separation.

In certain other embodiments electrical coagulation appliances could also be used to accelerate the precipitate agglomeration and separation. Mixing paddles in the reaction and buffering vessels could also be employed to further homogenize the chemical mixtures to assure rapid and complete chemical reactions.

Those skilled in the art will appreciate that many other additional refinements employing existing art to enhance the performance of the invention; especially in those situations of which one skilled in the art may be especially familiar.

What is claimed is:

1. A chemical device for reduction of iron in aqueous solution comprising:
a. a containment vessel confining an iron entrained aqueous solution;
b. a conveyance for adding phosphoric acid to said aqueous solution;
c. a conveyance for adding a base chemical to said aqueous solution; and
d. wherein addition of said phosphoric acid and said base chemical results in separation of entrained iron from said aqueous solution.

2. The device of claim 1 wherein the phosphoric acid is added first to drop the pH of the iron entrained aqueous solution.

3. The device of claim 1 wherein the phosphoric acid is added first and sufficiently to drop the pH of the iron entrained aqueous solution to 4 or less.

4. The device of claim 1 wherein the base chemical is added after said phosphoric acid addition to increase the pH of the iron entrained aqueous solution.

5. The device of claim 1 wherein the base chemical is added, after said phosphoric acid addition, sufficiently to increase the pH of the phosphoric acid dosed, iron entrained aqueous solution to 8.5 or more.

6. The device of claim 1 wherein the base chemical is sodium hydroxide:

7. The device of claim 1, comprising additional conveyances for adding one or more chemicals, wherein said chemicals agglomerate and enhance separation of iron compounds precipitating from the aqueous solution.

8. An agglomerating chemical of claim 7 being an anionic charged polymer flocculent.

9. The device of claim 1, comprising additional conveyances for adding one or more chemicals, sequentially, after the addition of said phosphoric acid and said base chemical, wherein said chemicals agglomerate and enhance separation of iron compounds precipitating from the aqueous solution.

10. A chemical device for reduction of iron in aqueous solution comprising:
a. a containment vessel confining an iron entrained aqueous solution;
b. a conveyance for adding phosphoric acid to the iron entrained aqueous solution;
c. a conveyance for adding a base chemical to the iron entrained aqueous solution;
d. an inlet liquid conveyance to the confinement vessel;
e. an outlet liquid conveyance from the confinement vessel;
f. a solids outlet conveyance from the confinement vessel; and
g. wherein said iron entrained aqueous solution is proffered via said liquid inlet conveyance into said confinement vessel, wherein said phosphoric acid and said base chemical are conveyed, respectively, into said aqueous solution, resulting in precipitation and separation of iron compounds, wherein said solids outlet conveyance purveys discharge from said confinement vessel as a separate and isolated product from the reduced iron aqueous solution product further conveyed from said confinement vessel via said liquid outlet conveyance.

11. The device of claim 10 wherein the phosphoric acid is added first to drop the pH of the iron entrained aqueous solution.

12. The device of claim 10 wherein the phosphoric acid is added first and sufficiently to drop the pH of the iron entrained aqueous solution to 4 or less.

13. The device of claim 10 wherein the base chemical is added after said phosphoric acid addition to increase the pH of the iron entrained aqueous solution.

14. The device of claim 10 wherein the base chemical is added, after said phosphoric acid addition, sufficiently to increase the pH of the phosphoric acid dosed, iron entrained aqueous solution to 8.5 or more.

15. The device of claim 10 wherein the base chemical is sodium hydroxide.

16. The device of claim 10, comprising additional conveyances for adding one or more chemicals, wherein said chemicals agglomerate and enhance separation of iron compounds precipitating from the aqueous solution.

17. An agglomerating chemical of claim 16 being an anionic charged polymer flocculent.

18. The device of claim 10, comprising an additional conveyances for adding one or more chemicals, sequentially, after the addition of said phosphoric acid and said base chemical, wherein said chemicals agglomerate and enhance separation of iron; compounds precipitating from the aqueous solution.

19. The device of claim 10, wherein said phosphoric acid conveyance purveys said phosphoric acid into said liquid inlet conveyance, prior to issuance into said confinement vessel.

20. The device of claim 10, wherein said phosphoric acid conveyance purveys said phosphoric acid into said liquid inlet conveyance, wherein a mixing appliance is further provided.

21. The device of claim 10, wherein said phosphoric acid conveyance and said base chemical conveyance purveys said phosphoric acid and said base chemical into said liquid inlet conveyance, prior to issuance into said confinement vessel.

22. The device of claim 10, wherein said phosphoric acid conveyance and said base chemical conveyance purveys said phosphoric acid and said base chemical into said liquid inlet conveyance, wherein mixing appliances are further provided.

23. The device of claim 10, wherein said phosphoric acid conveyance and said base chemical conveyance and further agglomerating chemical conveyances purveys said phosphoric acid and said base chemical as well as precipitate agglomerating chemicals into said liquid inlet conveyance, prior to issuance into said confinement vessel.

24. The device of claim 10, wherein said phosphoric acid conveyance and said base chemical conveyance and further agglomerating chemical conveyances purveys said phosphoric acid and said base chemical as well as precipitate agglomerating chemicals into said liquid inlet conveyance, wherein mixing appliances are further provided.

25. The device of claim 10, wherein said liquid inlet conveyance includes provision of a reaction vessel for receiving said phosphoric acid conveyance.

26. A chemical device for reduction of iron in aqueous solution comprising:
a. a containment vessel confining an iron entrained aqueous solution;
b. a conveyance for adding phosphoric acid to the iron entrained aqueous solution;
c. a conveyance for adding a base chemical to the iron entrained aqueous solution;
d. an inlet liquid conveyance to the confinement vessel;
e. an outlet liquid conveyance from the confinement vessel;
f. a solids outlet conveyance from the confinement vessel;
g. a buffering vessel;
h. a final liquid conveyance from the buffering vessel;
i. a conveyance to add an acidic solution; and
j. wherein said iron entrained aqueous solution is proffered via said liquid inlet conveyance into said confinement vessel, wherein said phosphoric acid and said base chemical are conveyed, respectively, into said aqueous solution, resulting in precipitation and separation of iron compounds, whereof said solids outlet conveyance purveys discharge from said confinement vessel as a separate and isolated product from the reduced iron aqueous solution product further conveyed from said confinement vessel via said liquid outlet conveyance into said buffering vessel, said reduced iron aqueous product being pH adjusted by said acidic solution conveyance, wherein suitably buffered, reduced iron aqueous solution product is discharged from said buffering vessel to process via said final liquid outlet conveyance.

27. The device of claim 26 wherein the phosphoric acid is added first to drop the pH of the iron entrained aqueous solution.

28. The device of claim 26 wherein the phosphoric acid is added first and sufficiently to drop the pH of the iron entrained aqueous solution to 4 or less.

29. The device of claim 26 wherein the base chemical is added after said phosphoric acid addition to increase the pH of the iron entrained aqueous solution.

30. The device of claim 26 wherein the base chemical is added, after said phosphoric acid addition, sufficiently to increase the pH of the phosphoric acid dosed, iron entrained aqueous solution to 8.5 or more.

31. The device of claim 26 wherein the base chemical is sodium hydroxide.

32. The device of claim 26, comprising additional conveyances for adding one or more chemicals, wherein said chemicals agglomerate and enhance separation of iron compounds precipitating from the aqueous solution.

33. An agglomerating chemical of claim 32 being an anionic charged polymer flocculent.

34. The device of claim 26, comprising an additional conveyances for adding one or more chemicals, sequentially, after the addition of said phosphoric acid and said base chemical, wherein said chemicals agglomerate and enhance separation of iron; compounds precipitating from the aqueous solution.

35. The device of claim 26, wherein said phosphoric acid conveyance purveys said phosphoric acid into said liquid inlet conveyance, prior to issuance into said confinement vessel.

36. The device of claim 26, wherein said phosphoric acid conveyance purveys said phosphoric acid into said liquid inlet conveyance, wherein a mixing appliance is further provided.

37. The device of claim 26, wherein said phosphoric acid conveyance and said base chemical conveyance purveys said phosphoric acid and said base chemical into said liquid inlet conveyance, prior to issuance into said confinement vessel.

38. The device of claim 26, wherein said phosphoric acid conveyance and said base chemical conveyance purveys said phosphoric acid and said base chemical into said liquid inlet conveyance, wherein mixing appliances are further provided.

39. The device of claim 26, wherein said phosphoric acid conveyance and said base chemical conveyance and further agglomerating chemical conveyances purveys said phosphoric acid and said base chemical as well as precipitate agglomerating chemicals into said liquid inlet conveyance, prior to issuance into said confinement vessel.

40. The device of claim 26, wherein said phosphoric acid conveyance and said base chemical conveyance and further agglomerating chemical conveyances purveys said phosphoric acid and said base chemical as well as precipitate agglomerating chemicals into said liquid inlet conveyance, wherein mixing appliances are further provided.

41. The device of claim 26, wherein said liquid inlet conveyance includes provision of a reaction vessel for receiving said phosphoric acid conveyance.

42. The device of claim 26, wherein a buffering product solids outlet conveyance proffers precipitate and agglomerated solids removal from said buffering vessel.

43. The device of claim 26, wherein a buffering product solids outlet conveyance proffers precipitate and agglomerated solids removal from said buffering vessel.

44. The device of claim 26, wherein said conveyance for an acidic solution purveys phosphoric acid.

45. The device of claim 26, comprising additional conveyances for adding one or more chemicals, wherein said chemicals agglomerate and enhance separation of precipitates which form as a buffering product.

46. The agglomerating chemicals of claim 45 being anionic polymer flocculants.

47. The device of claim 26, wherein said acidic solution conveyance purveys into said confinement vessel liquid outlet conveyance prior to entry into said buffering vessel.

48. The device of claim 26, wherein said acidic solution conveyance purveys into said confinement vessel liquid outlet conveyance prior to entry into said buffering vessel, wherein a mixing appliance is further provided.

49. The device of claim 26, comprising additional conveyances for adding one or more chemicals, wherein said chemicals agglomerate and enhance separation of precipitates which form as a buffering product, wherein said chemical conveyance proffers into said confinement vessel liquid outlet conveyance prior to said buffering vessel.

50. The device of claim 26, comprising additional conveyances for adding one or more chemicals, wherein said chemicals agglomerate and enhance separation of precipitates which form as a buffering product, wherein said chemical conveyance proffers into said confinement vessel liquid outlet conveyance prior to said buffering vessel, wherein a mixing appliance is further provided.
